(19) United States
(12) Patent Application Publication
(10) Pub. No.: US 2017/0318787 A1
(43) Pub. Date: Nov. 9, 2017

(54) Tangle-Free Pet Collar

(71) Applicant: Sam Osta, Citra, FL (US)

(72) Inventor: Sam Osta, Citra, FL (US)

(21) Appl. No.: 15/587,647

(22) Filed: May 5, 2017

Related U.S. Application Data
(60) Provisional application No. 62/332,048, filed on May 5, 2016.

(51) Int. Cl. A01K 27/00

(52) U.S. Cl. CPC A01K 27/001; A01K 27/005

(57) ABSTRACT

The present invention provides a tangle-free pet collar apparatus to be worn around the neck of an animal. The collar apparatus includes an outer wheel and an inner wheel, that when the inner wheel is set within the outer wheel a bearing is formed. The inner wheel and said outer wheel are free to rotate about each other upon forming a bearing. The collar apparatus further includes an elongated length of material having a first end and a second end, at least one inner wheel connection mechanism for attaching a leash, and at least one outer wheel connection mechanism. The first and second end of the elongated length of material, when fastened to the outer wheel, forms a collar for wearing about an animal's neck. This collar apparatus keeps the leash from tangling or knotting in addition to solving additional unmet needs.

### CROSS-REFERENCE TO RELATED APPLICATION

This application claims the benefit of U.S. Provisional Application No. 62/332,048, having a filing date of May 5, 2016, the disclosure of which is hereby incorporated by reference in its entirety and all commonly owned.

### FIELD OF INVENTION

The present invention relates to collars for animals. More particularly, the present invention relates to animal collars which do not bunch or tangle up. The present invention further relates to a collar for animals, including pets that can be used in conjunction with a leash which prevents bunching and entanglement of the leash when attached to the collar.

### BACKGROUND

While the exact timing is up for debate, dogs became known as a human companion roughly 12,000 years ago, when the wolf first became domesticated. They had many practical uses such as hunting, herding and guarding. Over the years this relationship of reliance on animals has turned into one of love and respect, and the reasons for owning animals have changed. Pets today are obtained for a number of reasons, including companionship, status, service and protection. Dogs have become known as man's best friend and in efforts to protect man's best friend, dog owners seek out protection for their furry friends. Dog and other animal owners desire safe and reliable control restraints for their pets.

Walking the household dog has been a pastime enjoyed by owner and dog for many years. Dog walking has also become a rather popular profession whereby the dog walker picks up a dog at its home and takes it and often many other dogs, often with 6 to 8 others, out for a walk and then returns the dog to their residence, as part of the dogs normal daily exercise or bathroom routine. Also growing in popularity is dog running, where an individual will come and pick up your dog and sometimes one other dog and will take the animal or animals for a run usually between one and ten miles.

Because of the widespread popularity and love for dogs, and the increase of pet owners who hire help to walk their dogs, the demand for a safe and reliable collar for dog walking has risen. While opinions vary in the professional dog walking community, some say that walking ten dogs at a time is okay, while others argue that no more than three is appropriate, they all agree that the leash and collars the dogs wear play an important role in the dog walking. The better the collar and leash, the safer the dog and the more dogs an individual can walk. The safety of the animal has become so important that some counties have passed ordinances restricting owners from tying up or tethering their animal without supervision. A safe and effective means for restrain and control of dogs and other pets has been a problem since dogs were first domesticated. Several attempts have been offered for the control and restraint of animals. The attempts fall into two main categories, collars and harnesses.

Harnesses are typically attached to the animal's fore-chest or upper torso and belly, and are detachably connected to a leash. Typically with a harness the leash is attached to a clip on the harness located on the animals back. Harnesses are not the best mechanism for animal control. First, the harness is worn on the fore-chest of the animal, close by to the shoulders and armpits an area with very delicate skin, where the animal often lacks hair to protect it. A poorly fitted harness can do more damage and discomfort than good, damaging blood vessels located in the armpit area and causing skin irritation. A harness that is too tight can rub and cause bruising. A harness that is too loose, an animal can easily slip out of. Second, a harness can be extremely challenging to put on the animal, particularly a young rambunctious puppy. Harnesses are typically cumbersome, requiring great efforts from the individual to adjust and properly fit the harness to the animal.

Collars provide a better solution for pet restraint, but current collars on the market fail to accommodate for all of the problems pet owners encounter. First, many collars detachably connect to a leash via a fixed connecting ring. Collars like these increase the risk of infection by damaging the skin of the animal's neck through abrasion when the collar chokes the animal's neck. While attempts to fix this have been made such as padded collars, the collar still pulls on the animal and bunches up, pulling tight on the animals neck causing health issues.

Stationary collars have entered the market to solve this abrasion problem, but these introduce a new problem of discomfort for the animal. The potential for harm to an animal greatly increases in the form of a potential choking hazard when the collar remains stationary on the animal because when the animal acts up or tries to run, there is far more pressure concentrated at one point on the animals neck. Additionally stationary collars have proved troublesome because the attachment mechanism provided for the leash often falls to the front of the animal when they are connected to a leash, causing knots in the leash and inter-twining and tangling between the animals legs and the leash.

No pet collar exists that keeps the leash from tangling or knotting, that does not cause abrasion to the animals sensitive arm pit areas, that prevents pressure from being applied at one central point on the animals neck and that is easy to put on the animal. Thus, there remains an unmet need.

### SUMMARY OF INVENTION

The present invention seeks to solve the unmet needs noted herein. Notwithstanding, additional advantages may be afforded by one or a combination of embodiments presented herein in excess of what has been described herein, thus nothing herein is intended to limit the advantages or solutions to problems in the field of dog collars or leashes that the present invention solves. In solving the unmet need, the present invention provides a tangle-free pet collar apparatus to be worn around the neck of an animal. The collar apparatus includes an outer wheel and an inner wheel, that when the inner wheel is set within the outer wheel a bearing is formed. The inner wheel and said outer wheel are free to rotate about each other upon forming a bearing. The collar apparatus further includes an elongated length of material having a first end and a second end, at least one inner wheel connection mechanism for attaching a leash, and at least one outer wheel connection mechanism. The first and second end of the elongated length of material, when fastened to the outer wheel, forms a collar for wearing about an animal's neck. This collar apparatus keeps the leash from tangling or knotting, does not cause abrasion to the animals sensitive arm pit areas, prevents pressure from being applied at one central point on the animals neck and is easy to put on the animal.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 is a flat top perspective view of the inventive 10 pet collar illustrating a 100 outer wheel, a 200 inner wheel, a 300 fastening mechanism, an amount of 400 elongated material, and a 500 leash. FIG. 1 further illustrates that the 200 inner wheel is contained within the 100 outer wheel forming a bearing. FIG. 1 also shows that the 400 elongated material attaches to the 100 outer wheel by at least one 300 outer fastening mechanism thus forming a collar. FIG. 1 also shows a 500 leash may connect to an inner fastening mechanism on the 200 inner wheel.

FIG. 2 provides perspective view of the inventive 10 pet collar illustrating a 100 outer wheel, a 200 inner wheel, an 300 outer fastening mechanism, an 310 inner fastening mechanism, an amount of 400 elongated material, and a 500 leash. FIG. 2 further illustrates that the 200 inner wheel is contained within the 100 outer wheel forming a bearing. FIG. 2 also shows that the 400 elongated material attaches to the 100 outer wheel by at least one 300 fastening mechanism, thus forming a collar. FIG. 1 also shows a 500 leash may connect to an 310 inner fastening mechanism on the 200 inner wheel. At least one 250 tension spring is connected between the 100 outer wheel and 200 inner wheel.

### DETAILED DESCRIPTION

The following detailed description is merely exemplary in nature and is in no way intended to limit the scope of the invention, its application, or uses, which may vary. The invention is described with relation to the non-limiting definitions and terminology included herein. These definitions and terminology are not designed to function as a limitation on the scope or practice of the invention, but are presented for illustrative and descriptive purposes only.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4

### Generally

The present invention contains the features of an inventive pet collar for providing a safe restraint collar, that prevents tangles, for an animal for walking an animal or for tethering an animal to a fixed surface such as a stake, tree, or a pulley attached to a lead line or clothesline. The inventive pet collar includes an outer wheel, and an inner wheel, where the inner wheel is set within the outer wheel to form a bearing, the inner wheel and the outer wheel each are free to rotate about each other, and an elongated length of material having a first end and a second end which is connected to the surface of the outer wheel through the use of at least one outer connection means forming a collar to be worn around an animals neck. The present invention further provides for at least one inner wheel connection mechanism for attaching a leash. In some embodiment, at least one tension spring is used to connect the inner wheel to the outer wheel.

### Outer Wheel and Inner Wheel

The inventive pet collar includes an outer wheel, and an inner wheel, where the inner wheel is set within the outer wheel to form a bearing, the inner wheel and the outer wheel each are free to rotate about each other. The bearing action of the outer wheel and the inner wheel prevents the leash from tangling around an animal. Without intending to be bound by any particular theory, when a leash is connected to the inner wheel, the inner wheel is free to rotate within the outer wheel to prevent the leash from tangling. The inner and outer wheel may be made of several materials known in the art, however, it is intended that the materials selected are to be suitable for withstanding stresses imparted by an animal pulling against the leash. In at least one embodiment, the inner and outer wheel are made from poly-vinyl chloride (PVC), plastic, ceramic, metal, wood, or combinations thereof. In certain embodiments a means for keeping the inner wheel rotational within the outer wheel is provided wherein the means is at least one ball bearing, a grease, a lubricant, or combinations thereof.

The inner wheel or the outer wheel may have one or more connection means. These connection means may include any connection means known in the art, including, but not limited to, a buckle, a clip, a clasp, a hasp, a carabiner, a button, a hook and loop, a c-clamp, a d-ring, a grommet and lacing, a hook and eye, or combinations thereof. The inner wheel connection means is intended for connecting to a leash or a tether. The inner wheel connection means is to be internal to the inner wheel thus allowing for the inner when and to rotate freely within the outer wheel. It is further intended that the outer wheel have at least one outer connection means for allowing for an elongated amount of material to be connected around an animals neck and held in place around the animals neck by the outer wheel, thus forming a collar.

### Collar

A collar is formed, as described above, by connecting an elongated amount of material around an animals neck and held in place around the animals neck by the outer wheel. The elongated material has a first end and a second end, and each of the first end and second end is connected to the outer wheel connection means.

The elongated material may be made from several materials known in the art such as leather, burlap, rubber, plastic, nylon, bamboo, cotton, synthetic fiber, polyester, wool, cotton, metal, chain, or combinations thereof. The elongated material may include a chain having a cord or fabric woven along its length. In certain embodiments where the elongated material is a fabric, the fabric may take the form of a rope, strip, batting, or other item softer and/or more resilient than the chain and may be made from a natural fiber, such as cotton or hemp, leather or animal hide, or a manmade material, such as polypropylene, neoprene, other rubbers or plastics. It is intended that the material selected for the elongated material is somewhat resilient and/or flexible in order to adapt to neck of the animal and to prevent choking when a stress is imparted by a leash, a tether, or the animal pulling against the lease or tether. In at least one embodiment, the elongated length of material is adjustable to conform to the size of the animals neck by adjusting the length of said elongated length of material. The elongated material may be adjustable through any known length adjusting means known in the art.

### Tension Spring

The present invention further provides for at least one tension spring connecting the inner wheel to the outer wheel. The tension spring is intended to limit the length of travel of the inner wheel within the outer wheel, but it is not intended to prevent the rotation of the inner wheel within the outer wheel. Without intending to limit the invention, and without being bound by any particular theory, the use of the tension spring will allow the inner wheel to return to its original position within the outer wheel, while providing some tension to the animals neck to steer the animal to no longer fight against the leash tension.

### EXAMPLES

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

### Example 1

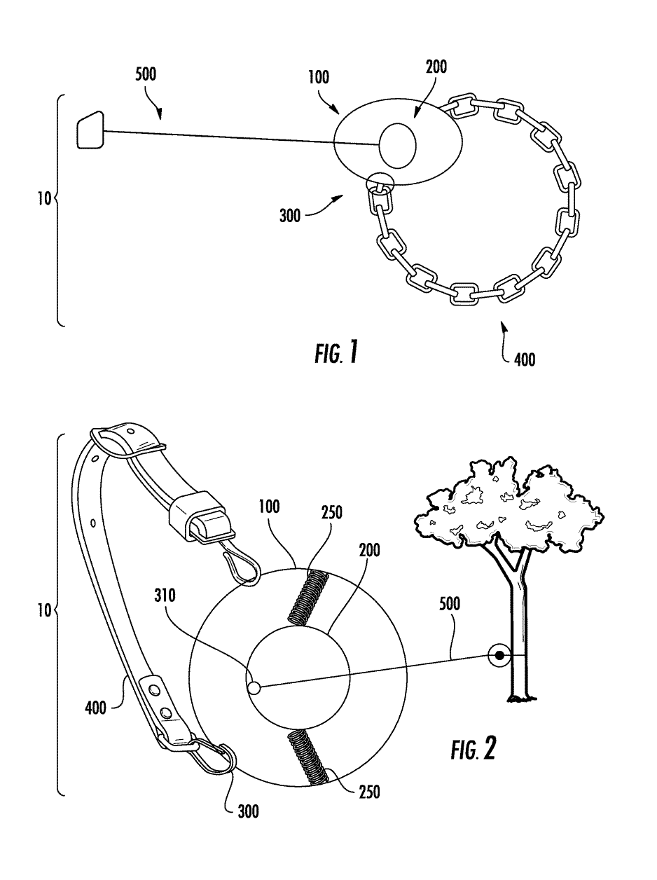

A 10 tangle-free collar is provided, as illustrated in FIG. 1 and FIG. 2 which includes an 100 outer wheel, an 200 inner wheel, an 300 outer fastening mechanism, an 310 inner fastening mechanism, and an 400 elongated material. The 200 inner wheel is contained within the 100 outer wheel forming a bearing. The 400 elongated material attaches to the 100 outer wheel by at least one 300 fastening mechanism forming a collar. Two 250 tension springs are connected between the 100 outer wheel and 200 inner wheel.

The collar is fastened around an animals neck by connecting the 400 elongated material to the 300 outer fastening mechanism. A 500 leash is used to connect to the 310 inner fastening mechanism on the 200 inner wheel. When the animal owner is walking the dog, the dog may weave and tug causing 200 the inner wheel to rotate within the 300 outer wheel, and preventing the leach from tangling around the animals legs or neck.

### OTHER EMBODIMENTS

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

1. A tangle-free pet collar apparatus to be worn around the neck of an animal, the apparatus comprising:
an outer wheel;
an inner wheel, wherein said inner wheel is set within said outer wheel to form a bearing, wherein said inner wheel and said outer wheel are free to rotate about each other;
an elongated length of material having a first end and a second end;
at least one inner wheel connection mechanism for attaching a leash; and
at least one outer wheel connection mechanism;
wherein said first and second end of said elongated length of material, when fastened to said outer wheel, forms a collar for wearing about an animals neck.

2. The apparatus of claim 1 wherein said elongated length of material is made of leather, burlap, rubber, plastic, nylon, bamboo, cotton, synthetic fiber, polyester, wool, cotton, metal, chain, or combinations thereof.

3. The apparatus of claim 1 wherein said inner wheel fastening mechanism or said outer wheel fastening mechanism is a buckle, a clip, a clasp, a hasp, a carabiner, a button, a hook and loop, a c-clamp, a d-ring, a grommet and lacing, a hook and eye, or combinations thereof.

4. The apparatus of claim 1 wherein said elongated length of material is adjustable to conform to the size of the animals neck by adjusting the length of said elongated length of material.

5. The apparatus of claim 1 further comprising at least one tension spring connecting said inner wheel to said outer wheel.
